(19) United States
(12) Patent Application Publication
(10) Pub. No.: US 2015/0030888 A1
(43) Pub. Date: Jan. 29, 2015

(54) METHODS AND SYSTEMS FOR MICROBIAL FUEL CELLS WITH IMPROVED CATHODES

(71) Applicant: Arizona Board of Regents, for and on behalf of Arizona State University, Scottsdale, AZ (US)

(72) Inventors: Sudeep Popat, Chandler, AZ (US); Cesar Torres, Tempe, AZ (US); Bruce Rittmann, Tempe, AZ (US); Dongwon Ki, Chandler, AZ (US)

(73) Assignee: Arizona Board of Regents, for and on behalf of, Arizona State University, Scottsdale, AZ (US)

(21) Appl. No.: 14/379,992

(22) PCT Filed: Feb. 20, 2013
(86) PCT No.: PCT/US2013/026943

§ 371 Date: Aug. 20, 2014

Related U.S. Application Data
(60) Provisional application No. 61/601,447, filed on Feb. 21, 2012.

(51) Int. Cl. H01M 8/16; H01M 8/04

(52) U.S. Cl. CPC H01M 8/16; H01M 8/04201
USPC 429/2; 429/514; 429/401

(57) ABSTRACT

Methods and systems for microbial fuel cells with unproved cathodes are provided, in accordance with some embodiments, methods for microbial fuel cells with improved cathodes are provided. The methods comprising: abiotically reducing oxygen on a cathode having a catalyst layer bound to a gas diffusion layer using an anion conductive polymer, consequently accumulating Off at the catalyst layer, and reducing local pH by conducting the OH″ away from the catalyst layer, directly or by transport of anionic buffers that act as OH″ carriers, through the anion conductive polymer, in accordance with some embodiments, a system for microbial fuel cells is provided. The system comprising: a container, an anode, anode-respiring bacteria, and a cathode having a catalyst layer bound to a gas diffusion layer using an anion conductive polymer.

### CROSS REFERENCE TO RELATED APPLICATION

This application claims the benefit of U.S. Provisional Patent Application No. 61/601,447, filed Feb. 21, 2012, which is hereby incorporated by reference herein in its entirety.

### STATEMENT REGARDING FEDERALLY SPONSORED RESEARCH OR DEVELOPMENT

This invention was made with government support under Grant No. N00014-10-M-0231 awarded by the Office of Naval Research. The government has certain rights in the invention.

### TECHNICAL FIELD

The disclosed subject matter relates to methods and systems for microbial fuel cells with improved cathodes.

### Background

Microbial fuel cells (MFCs) are devices that can be used to achieve sustainable wastewater treatment based on their ability to convert organics present in wastewater into electrical power. Anode-respiring bacteria (ARB) in an MFC can oxidize these organic compounds and transfer electrons to an anode. These electrons can move through a circuit to a cathode of the MFC Where oxygen can be reduced, usually on a metal catalyst. The use of MFCs to remove contaminants from water can generate energy as opposed to the more traditional wastewater treatment processes, which use enemy.

A binder commonly used in cathodes in MFCs is the polymer Nafion, which contains sulfonate moieties that make it capable of transporting cations. Oxygen reduction in MFCs can produce OH⁻, an anion. Nafion can provide resistance to the transport of OH⁻ either directly or when OH⁻ is combined in anionic buffers, such as phosphate and carbonate species that act as OH⁻ carriers. This resistance can lead to an increase in local cathode pH in MFCs.

One of the major challenges in the use of MFCs is poor cathode performance under typical MFC conditions.

### SUMMARY

Methods for microbial fuel cells with improved cathodes are provided. In accordance with some embodiments, methods for microbial fuel cells with improved cathodes are provided, the methods comprising: abiotically reducing oxygen on a cathode having a catalyst layer bound to a gas diffusion layer using an anion conductive polymer, consequently accumulating OH⁻ at the catalyst layer, and reducing local pH by conducting the OH⁻ away from the catalyst layer, directly or by transport of anionic butlers that act as OH⁻ carriers, through the anion conductive polymer. In accordance with some embodiments, these methods further comprise: oxidizing organic compounds using an anode-respiring bacteria. In accordance with sonic embodiments, these methods further comprise: transferring electrons from the anode-respiring bacteria to an anode. In accordance with some embodiments, these methods further comprise: transferring the electrons through a circuit, wherein the circuit contains a load, to the cathode. In accordance with some embodiments, the catalyst layer comprises at least one of carbon and a metal that can be supported on carbon. In accordance with some embodiments, the catalyst layer reduces oxygen. In accordance with some embodiments, the gas diffusion layer transports oxygen to the catalyst layer. In accordance with some embodiments, the catalyst layer contains an anion conductive polymer. In accordance with some embodiments, the anion conductive polymer has a high diffusion coefficient for OH⁻ and anionic buffer species. In accordance with some embodiments, the anion conductive polymer contains quaternary ammonium or phosphonium moieties. In accordance with some embodiments, the cathode is an air-cathode.

Systems for microbial fuel cells with improved cathodes are provided. In accordance with some embodiments, systems for microbial fuel cells with improved cathodes are provided, the systems comprising: a container, an anode, anode-respiring bacteria, and a cathode having a catalyst layer bound to a gas diffusion layer using an anion conductive polymer. In accordance with some embodiments, the container comprises a half-cell, a single-chamber cell, or a dual chamber cell. In accordance with some embodiments, the catalyst layer comprises at least one of carbon and a metal that can be supported on carbon. In accordance with some embodiments, the catalyst layer is configured to reduce oxygen. In accordance with some embodiments, the was diffusion layer is configured to transport oxygen to the catalyst layer. In accordance with some embodiments, the catalyst layer contains an anion conductive polymer. In accordance with some embodiments, the anion conductive polymer has a high diffusion coefficient for OH⁻ and anionic buffer species. In accordance with some embodiments, the anion conductive polymer contains quaternary ammonium or phosphonium moieties. In accordance with some embodiments, the anode-respiring bacteria oxidizes organic compounds and transfers electrons to the anode. In accordance with some embodiments, these systems further comprise a circuit and a load, wherein the electrons move through the circuit to the cathode. In accordance with some embodiments, the cathode is an air-cathode.

### BRIEF DESCRIPTION OF THE DRAWINGS

FIG, 1 is a diagram of a microbial fuel cell having an anode and an air-cathode in accordance with some embodiments.

FIG. 2(a) is a schematic of OH⁻ transport from a cathode layer to a bulk liquid electrolyte in accordance with some embodiments.

FIG. 2(b) is a schematic of OH⁻ transport from an active catalyst site to a bulk cathode catalyst layer in accordance with some embodiments.

FIG. 3 is a graph of cathode potential versus current density for a cathode constructed with a Nafion binder and with an anion conductive binder, such as AS-4 binder, with and without the presence of a CO₂ feed, in accordance with some embodiments.

### DETAILED DESCRIPTION

Methods and systems for microbial fuel cells with improved cathodes are provided.

In accordance with some embodiments, FIG. 1 shows an MFC 100, which can include an anode 102 and an air-cathode 104. MFC 100 can include ARB 106, which can oxidize organic compounds and transfer electrons to anode 102. These electrons can move through a circuit including a load to cathode 104. Cathode 104 can include a gas diffusion layer 110 which can transport O₂ to catalyst 108, where oxygen reduction can occur. Catalyst 108 can be a metal, for example, platinum, iron, cobalt, manganese, and/or an other material suitable for use in MFCs, such as carbon. Catalyst 108 can be supported on carbon 112 and bound to gas diffusion layer 110 using a polymer binder. In some embodiments, catalyst 108 can be implemented as carbon, and catalyst 108 and carbon 112 can be combined. This configuration can create a “three-phase boundary” where oxygen reduction can occur.

The cathodic oxygen reduction reaction of MFC 100, as shown in FIG. 1, can proceed as follows:

O₂H₂O+4e′→4OH⁻

The reduction of oxygen produces OH⁻, which can accumulate at the cathode and can result in an increase in the local pH of the cathode. As reflected by the Nernst equation, an increase in one pH unit can decrease the redox potential for oxygen reduction by approximately 59 mV (millivolts) at room temperature, which can affect cathode performance. For example, under typical MFC conditions, at current densities of 5-10 A/M² (ampere/meter squared), the local pH on the cathode can increase to more than 12, which is representative of a loss of more than 0.3 V (volts) or more than 60% of all cathodic potential losses.

Potential losses at the cathode can be a reflection of poor cathode performance. Cathodic potential losses have been shown to be greater than anodic potential losses. For example, ARB can obtain maximum current densities of approximately 10 A/m² with anodic potential losses of only 0.1-0.2 V, while cathodic potential losses at the same current densities can be more than 0.5 V.

Potential losses at the cathode, due to pH differences between an anode and a cathode in MFCs, can occur when a membrane is used to separate an anode chamber from a cathode chamber. The losses can occur when cations, other than H⁺ (a product of anode respiration), are transported from the anode chamber to the cathode chamber via a commonly used cation exchange membrane (CEM). This can lead to an increase in the pH of the cathode chamber. Cathodic potential losses may be improved through use of an anion exchange membrane (AEM) in place of a CEM. However, even when a MFC design excludes a membrane, decreases in the pH can still occur because the transport of OH⁻ from the cathode to an electrolyte, in this case the bulk liquid, can be inherently slow.

The slow transport of OH⁻ may be due to resistances that can exist within cathode catalyst layer 114 and in diffusion boundary layer 116 which form at the interface of cathode 104 and bulk liquid 118. In accordance with some embodiments, rapidly transporting OH⁻ away from catalyst 108 to an electrolyte in contact with catalyst 108 can help to maintain the local pH and improve cathode performance.

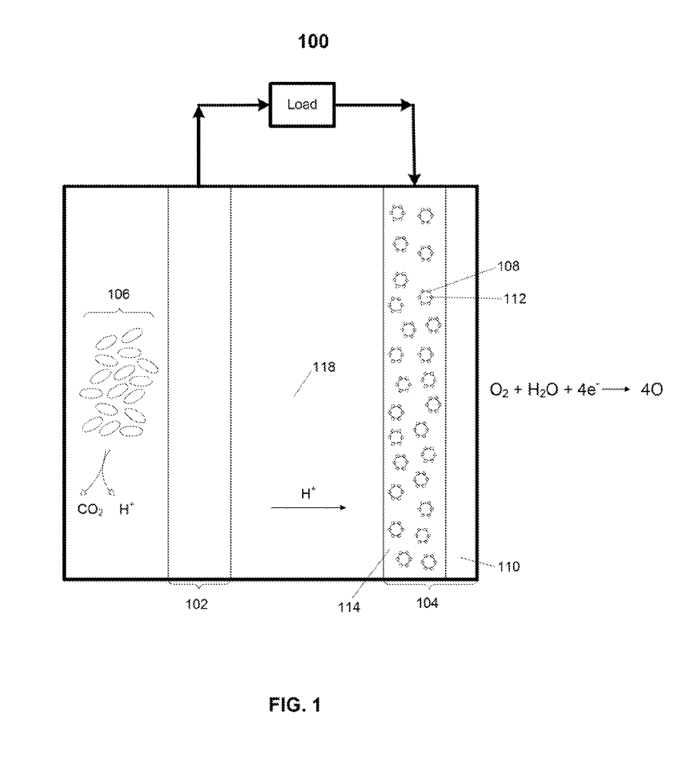

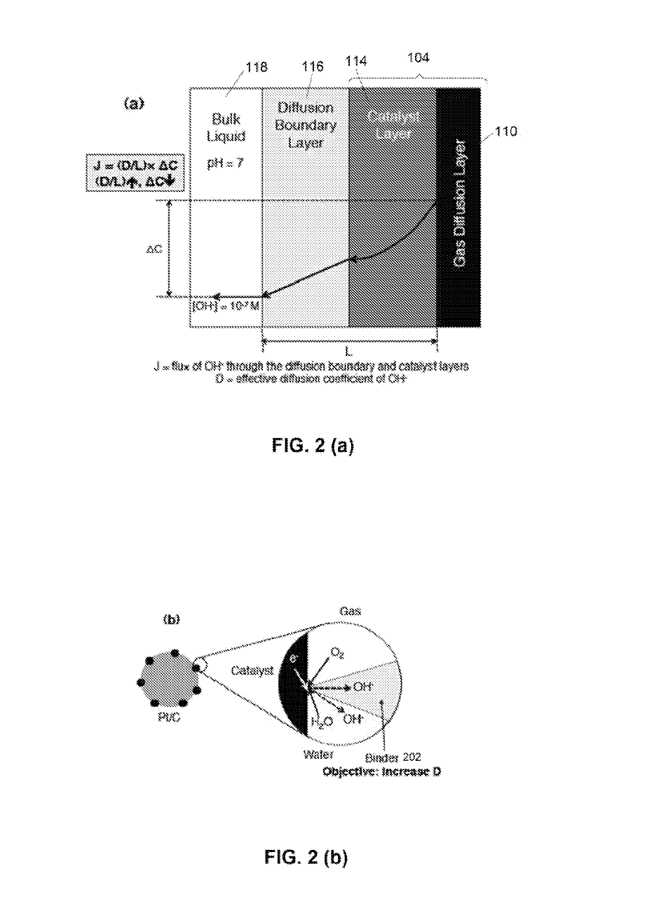

Improving OH⁻ transport can be done by making changes at cathode catalyst layer 114. FIG. 2(a) is a schematic showing the transport of OH⁻ from cathode catalyst layer 114 to bulk liquid 118. The flux of OH⁻ through each layer depends on the diffusion coefficient of OH⁻ (D) in each layer, as well as the thickness of each layer (L). A large D/L can maintain a high flux of OH⁻ with smaller concentration gradients, which can result in a lower local pH. FIG. 2(b) shows that the transport of OH⁻ away from cathode catalyst layer 114 can occur through polymer binder 202. In accordance with some embodiments, selecting polymer binders with high diffusion coefficients (D) for OH⁻ can result in a high D/L, which can diminish OH⁻ transport resistance and pH based potential losses.

In accordance with some embodiments, Nafion can he replaced with a polymer binder that has high diffusion coefficients (D) for OH⁻, for example, anion conductive polymers. Anion conductive polymers can contain quaternary ammonium moieties that can achieve high diffusion coefficients. Use of anion conductive polymers when constructing cathodes for MFCs can allow for rapid OH⁻ transport either as OH⁻ itself or through the transport of buffers, that are also anionic, as OH⁻ carriers.

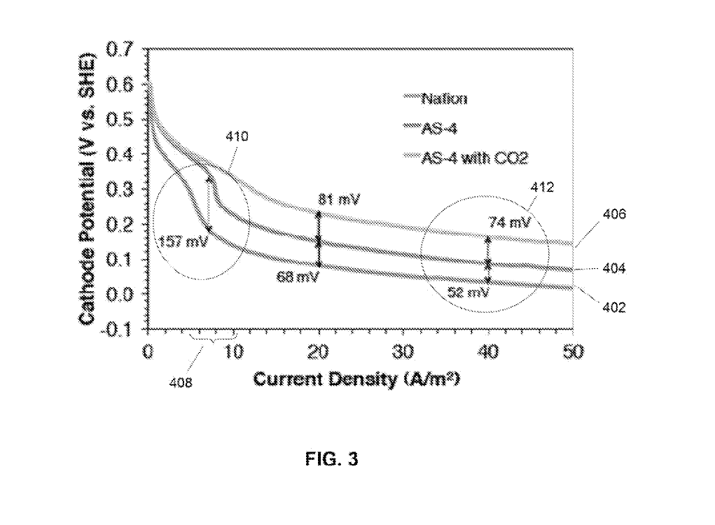

FIG. 3 is a graph of cathode potential versus current density for a cathode constructed with a Nafion binder and an anion conductive binder, such as AS-4 binder, with and without the presence of a CO₂ feed, in accordance with some embodiments. Cathodes of 9 cm² geometric, surface area with platinum bound to carbon (Pt/C) catalysts were constructed using the same amount of grams of polymer as binder in each case. Then, linear sweep voltammetry (LSV) on the cathodes was performed in 100 mM phosphate buffer (pH 7.2) in 15 mL gas diffusion half-cells from open circuit potential to the potential where 50 A/m² current was observed. A saturated calomel electrode was used as the reference electrode and a stainless steel rod of 10 cm² was used as the counter electrode.

To ensure validity of the data, Electrochemical Impedance Spectroscopy (EIS) analysis was performed at 100 kHz (kilo-Hertz) with sinusoidal amplitude of 10 mV before each LSV to determine the Ohmic loss between the cathode and the reference electrode. All LSVs were corrected for the Ohmic loss.

Additionally, LSVs were performed with 5% CO₂ fed to the cathode to evaluate if additional buffer, in the form of bicarbonate, could aid in improving cathode performance in the absence of a membrane and with the anion conductive binder.

FIG. 3 shows the i-R (Ohmic) corrected LSVs of cathodes constructed with Nafion binder 402 and AS-4 binder 404 and 406. AS-4 binder 406 represents LSVs performed with a 5% CO₂ feed. In FIG. 3, at a given current density, AS-4 binder 404 is shown to have higher cathode potentials compared to Nafion binder 402. AS-4 binder 404 experienced smaller potential losses due to higher DL values for OH⁻ and anionic buffers. Not shown here, it has been previously determined that the D/L for AS-4 increases by 60% compared to Nafion when considering transport only of OH⁻, which results in a savings of 40 mV at 5-10 A/m².

FIG. 3 shows that within 5-10 A/m² (current density range 408), at region 410, Nafion binder 402 demonstrates potential losses of more than 100 mV when compared to AS-4 binder 404. At a current density of 7.5 A/m², the cathode with AS-4 binder 404 shows a savings of 157 mV compared to that with Nafion binder 402, indicating that, at this current density, the local cathode pH was at least 2.7 units lower in the former. The savings of 100 mV is more than the 40 mV savings previously observed. for AS-4 and may be attributed to the improved transport also of phosphate buffer acting as an OH⁻ carrier. These results show that cathodes with AS-4 binder perform better than those with Nafion binder with a savings of more than 0.15 V, and in a typical MFC setting can allow for the production of greater than 90% more power compared to cathodes with Nafion binder.

In accordance with some embodiments, the data shown in FIG. 3, demonstrate that an anion conductive binder, such as AS-4, can increase Di at the cathode of an MFC and reduce cathode potential losses, which can lead to improved cathode performance.

FIG. 3 also shows that adding CO₂ to the cathode with AS-4 binder (AS-4 binder 406) did not improve cathode potentials in the low current density range (0-6 A/m²); however, at current densities greater than 10 A/m², for example as shown in region 412, savings of more than 70 mV could be seen as compared to AS-4 binder 404, and of greater than 120 mV compared to Nafion binder 402. Higher cathode potentials at these current densities may be due to the transport of OH⁻ across cathode catalyst layer 114 and diffusion boundary layer 110 by CO₂.

In accordance with some embodiments, anion-conductive binders containing quaternary phosphonium moieties having higher anion exchange capacities than those with quaternary ammonium moieties may additionally or alternatively be used as a binder.

In accordance with some embodiments, an air-cathode as it is applied in single-chamber microbial fuel cells is described; however, use of an anion conductive polymer to improve cathode performance can apply to the following classes of biological fuel cells that currently use Nafion as the binder in the cathode: single-chamber air cathode microbial fuel cells that use a metal catalyst cathode; single-chamber air cathode microbial fuel cells that use activated carbon as the cathode; dual-chamber air cathode microbial fuel cells with membrane electrode assemblies that use a binder with metal or activated carbon catalysts; dual chamber microbial fuel cells that use a carbon cloth cathode containing metal or activated carbon catalysts; air-cathode enzymatic biofuel cells with membrane electrode assemblies that use a binder with metal or activated carbon catalysts; dual chamber enzymatic biofuel cells that use a carbon cloth cathode containing metal or activated carbon catalysts; and/or any other fuel cell that uses Nafion as the polymer binder in the cathode and that requires improved OH⁻ transport.

Although the invention has been described an illustrated in the foregoing illustrative embodiments, it is understood that the present disclosure has been made only by way of example, and that numerous changes in the details of implementation of the invention can be made without departing from the spirit and scope of the invention, which is only limited by the claim which follows. Features of the disclosed embodiments can be combined and rearranged in various ways.

What is claimed is:

1. A method for microbiol fuel cells with improved cathodes comprising:
abiotically reducing oxygen on a cathode having a catalyst layer bound to a gas diffusion layer using an anion conductive polymer;
consequently accumulating OH⁻ at the catalyst layer; and
reducing local pH by conducting the OH⁻ away from the catalyst layer, directly or by transport of anionic buffers that act as OH⁻ carriers, through the anion conductive polymer.

2. The method of claim 1, further comprising oxidizing organic compounds using an anode respiring bacteria.

3. The method of claim 2, further comprising transferring electrons from the anode-respiring bacteria to an anode.

4. The method of claim 2, further comprising transferring, the electrons through a circuit, wherein the circuit contains a load, to the cathode.

5. The method of claim 1, wherein the catalyst layer comprises at least one of carbon and a metal that can be supported on carbon.

6. The method of claim 1, wherein the catalyst layer reduces oxygen.

7. The method of claim 1, wherein the gas diffusion layer transports oxygen to the catalyst layer.

8. The method of claim 1, wherein the catalyst layer contains an anion conductive polymer.

9. The method of claim 1, wherein the anion conductive polymer has a high diffusion coefficient for OH⁻ and anionic buffet species.

10. The method of claim 1, wherein the anion conductive polymer contains quaternary ammonium or phosphonium moieties.

11. The method of claim 1, wherein the cathode is an air-cathode.

12. A system for microbial fuel cells with improved cathodes comprising:
a container;
an anode;
anode-respiring bacteria; and
a cathode having a catalyst layer bound to a gas diffusion layer using an anion conductive polymer.

13. The system of claim 12, wherein the container comprises a half-cell, a single-chamber cell, or a dual chamber cell.

14. The system of claim 12, wherein the catalyst layer comprises at least one of carbon and a metal that can be supported on carbon.

15. The system of claim 12, wherein the catalyst layer is configured to reduce oxygen.

16. The system of claim 12, wherein the gas diffusion layer is configured to transport oxygen to the catalyst layer.

17. The method of claim 12, wherein the catalyst layer contains an anion conductive polymer.

18. The system of claim 12, wherein the anion conductive polymer has a high diffusion coefficient for OH⁻ and anionic buffer species.

19. The system of claim 12, wherein the anion conductive polymer contains quaternary ammonium or phosphonium moieties.

20. The system of claim 12, wherein the anode-respiring bacteria oxidizes organic compounds and transfers electrons to the anode.

21. The system of claim 20, further comprising a circuit and a load, wherein the electrons move through the circuit to the cathode.

22. The system of claim 12, wherein the cathode is an air-cathode.
